(19) United States
(12) Patent Application Publication
(10) Pub. No.: US 2005/0149890 A1
(43) Pub. Date: Jul. 7, 2005

(54) Programming reconfigurable packetized networks

(76) Inventors: Vicki W. Tsai, Mountain View, CA (US); Ernest T. Tsui, Cupertino, CA (US)

Correspondence Address: LeMoine Patent Services, PLLC;c/o PortfolioIP, P.O.Box 52050, Minneapolis, MN, 55402, US

(21) Appl. No.: 10/750,582

(22) Filed: Dec. 29, 2003

(51) Int. Cl. G06F 17/50

(52) U.S. Cl. 716/3

(57) ABSTRACT

A configurable circuit including a heterogeneous mix of processing elements is programmed.

### FIELD

The present invention relates generally to reconfigurable circuits, and more specifically to programming reconfigurable circuits.

### BACKGROUND

Some integrated circuits are programmable or configurable. Examples include microprocessors and field programmable gate arrays. As programmable and configurable integrated circuits become more complex, the tasks of programming and configuring them also become more complex.

### BRIEF DESCRIPTION OF THE DRAWINGS

FIG. 1 shows a block diagram of a reconfigurable circuit;

FIG. 2 shows a diagram of a reconfigurable circuit design flow;

FIG. 3 shows a diagram of an electronic system in accordance with various embodiments of the present invention; and

FIGS. 4 and 5 show flowcharts in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

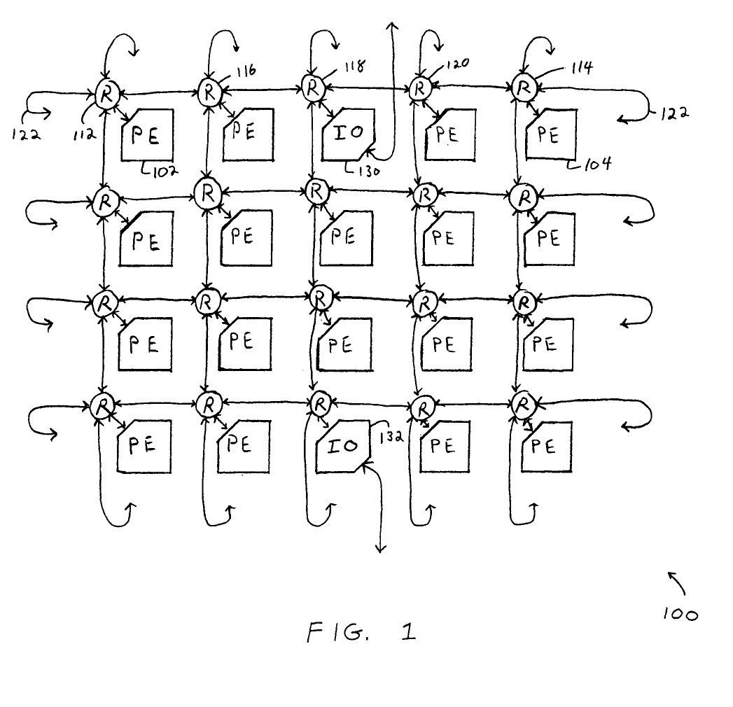

FIG. 1 shows a block diagram of a reconfigurable circuit. Reconfigurable circuit 100 includes a plurality of processing elements (PEs) and a plurality of interconnected routers (Rs). In some embodiments, each PE is coupled to a single router, and the routers are coupled together in toroidal arrangements. For example, as shown in FIG. 1, PE 102 is coupled to router 112, and PE 104 is coupled to router 114. Also for example, as shown in FIG. 1, routers 112 and 114 are coupled together through routers 116, 118, and 120, and are also coupled together directly by interconnect 122 (shown at left of R 112 and at right of R 114). The various routers (and PEs) in reconfigurable circuit 100 are arranged in rows and columns with nearest-neighbor interconnects, such that each row of routers is interconnected as a toroid, and each column of routers is interconnected as a toroid. In some embodiments, each router is coupled to a single PE, and in other embodiments, each router is coupled to more than one PE.

In some embodiments of the present invention, configurable circuit 100 may include various types of PEs having a variety of different architectures. For example, PE 102 may include a programmable logic array that may be configured to perform a particular logic function, while PE 104 may include a processor core that may be programmed with machine instructions. In general, any number of PEs with a wide variety of architectures may be included within configurable circuit 100.

As shown in FIG. 1, configurable circuit 100 also includes input/output (IO) elements 130 and 132. Input/output elements 130 and 132 may be used by configurable circuit 100 to communicate with other circuits. For example, IO element 130 may be used to communicate with a host processor, and 10 element 132 may be used to communicate with an analog front end such as a radio frequency (RF) receiver or transmitter. Any number of 10 elements may be included in configurable circuit 100, and their architectures may vary widely. Like PEs, IOs may be configurable, and may have differing levels of configurability based on their underlying architectures.

In some embodiments, each PE is individually configurable. For example, PE 102 may be configured by loading a table of values that defines a logic function, and PE 104 may be configured, or “programmed,” by loading a machine program to be executed by PE 104. Further, in some embodiments, power supply voltage values and clock frequencies for various PEs may be configurable. By modifying power supply voltages, clock frequencies, and other parameters, intelligent tradeoffs between speed, power, and other variables may be made during the design phase of a particular configuration.

In some embodiments, some PEs are more flexible (that is, programmable) than others because they can be programmed to do a variety of functions. Other PEs are less flexible because they can only perform a very specific type of function. Less flexible PEs are referred to as “configurable,” and more flexible PEs are referred to as “programmable.” The degree of flexibility that makes a PE configurable as opposed to programmable is chosen somewhat arbitrarily. The terms “configurable” and “programmable” are used herein as qualitative terms to qualitatively differentiate between different types of PEs, and are not meant to limit the invention in any way. In some embodiments, PEs fall somewhere between configurable and programmable.

In some embodiments, the routers communicate with each other and with PEs using packets of information. For example, if PE 102 has information to be sent to PE 104, it may send a packet of data to router 112, which routes the packet to router 114 for delivery to PE 104. Packets may be of any size. In embodiments that include various types of PEs that communicate using packets, configurable circuit 100 may be referred to as a “packet-based network of heterogeneous processing elements.”

Configurable circuit 100 may be configured by receiving configuration packets through an IO element. For example, IO element 130 may receive configuration packets that include configuration information for various PEs and IOs, and the configuration packets may be routed to the appropriate elements. Configurable circuit 100 may also be configured by receiving configuration information through a dedicated programming interface. For example, a serial interface such as a serial scan chain may be utilized to program configurable circuit 100.

Configurable circuit 100 may have many uses. For example, configurable circuit 100 may be configured to instantiate particular physical layer (PHY) implementations in communications systems, or to instantiate particular media access control layer (MAC) implementations in communications systems. In some embodiments, multiple configurations for configurable circuit 100 may exist, and changing from one configuration to another may allow a communications system to quickly switch from one PHY to another, one MAC to another, or between any combination of multiple configurations.

In some embodiments, configurable circuit 100 is part of an integrated circuit. In some of these embodiments, configurable circuit 100 is included on an integrated circuit die that includes circuitry other than configurable circuit 100. For example, configurable circuit 100 may be included on an integrated circuit die with a processor, memory, or any other suitable circuit. In some embodiments, configurable circuit 100 coexists with radio frequency (RF) circuits on the same integrated circuit die to increase the level of integration of a communications device. Further, in some embodiments, configurable circuit 100 spans multiple integrated circuit dice.

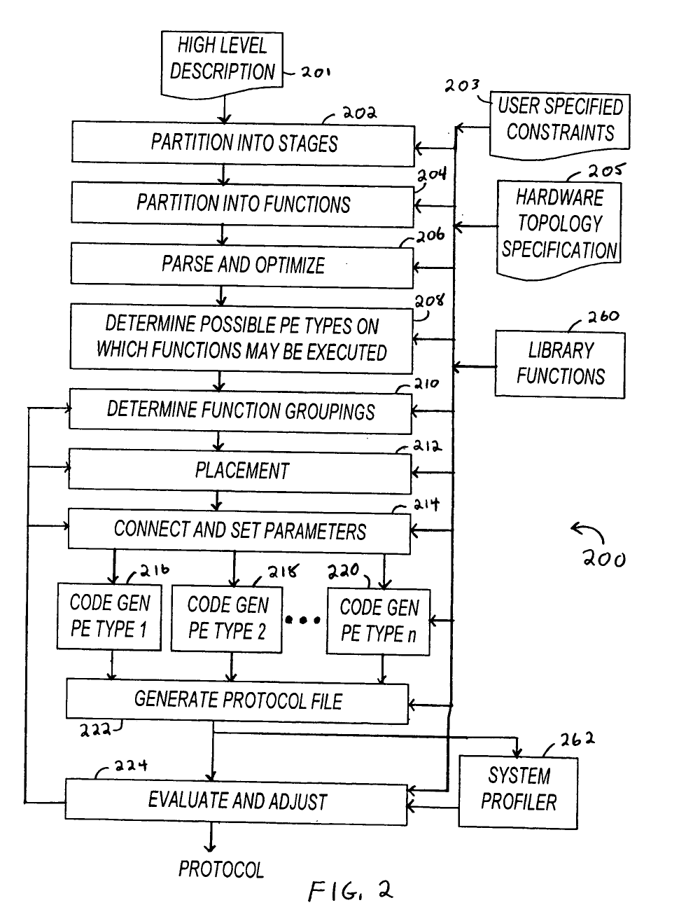

FIG. 2 shows a diagram of a reconfigurable circuit design flow. Design flow 200 represents various embodiments of design flows to process a high-level design description and create a configuration for configurable circuit 100 (FIG. 1). The various actions represented by the blocks in design flow 200 may be performed in the order presented, or may be performed in a different order. Further, in some embodiments, some blocks shown in FIG. 2 are omitted from design flow 200. Design flow 200 may accept one or more of: a high-level description 201 of a design for a configurable circuit, user-specified constraints 203, and/or a hardware topology specification 205. Hardware topology specification 205 may include information describing the number, arrangement, and types of PEs in a target configurable circuit.

High-level description 201 includes information describing the operation of the intended design. The intended design may be useful for any purpose. For example, the intended design may be useful for image processing, video processing, audio processing, or the like. The intended design is referred to herein as a “protocol,” but this terminology is not meant to limit the invention in any way. In some embodiments, the protocol specified by high-level description 201 may be in the form of an algorithm that a particular PHY, MAC, or combination thereof, is to implement. The high-level description may be in the form of a procedural or object-oriented language, such as C or C++, or may be written in a specialized, or “stylized” version of a high level language.

User specified constraints 203 may include constraints such as minimum requirements that the completed configuration should meet, or may include other information to constrain the operation of the design flow. The constraints may be related to the target protocol, or they may be related to overall goals of design flow 200, such as mapping and placement. Protocol related constraints may include latency and throughput constraints. In some embodiments, various constraints are assigned weights so that they are given various amounts of deference during the operation of design flow 200. In some embodiments, constraints may be listed as requirements or preferences, and in some embodiments, constraints may be listed as ranges of parameter values. In some embodiments, constraints may not be absolute. For example, if the target reconfigurable circuit includes a data path that communicates with packets, the measured latency through part of the protocol may not be a fixed value but instead may be one with a statistical variation.

Overall mapping goals may include such constraints as low power consumption and low area usage. Any combination of the global, overall goals may be specified as part of user-specified constraints 203. Satisfying various constraints involves tuning various parameters, such as PE clock frequencies and functions' input block size and physical output packet size. These parameters and others are described more fully below.

In design flow 200, the high-level description 201 is partitioned into stages at 202 and partitioned into functions at 204. Partitioning into stages refers to breaking a protocol into non-overlapping segments in time where different processing may occur. For example, at a very high level, any protocol can be broken into a transmit path and a receive path. The receive path may be further partitioned into stages such as acquisition and steady-state. Each of these stages may be partitioned into smaller stages as well, depending on the implementation.

Once a protocol has been partitioned into stages, the stages may be further partitioned into functions. Functions may serve data path purposes or control path purposes, or some combination of the two. Data path functions process blocks of data and send their output data to other data path functions. In some embodiments, these functions are defined using a producer-consumer model where a “producer” function produces data that is consumed by a “consumer” function. Utilizing data path functions that follow a producer-consumer model allows algorithms that are heavy in data flow to be mapped to a configurable circuit such as configurable circuit 100 (FIG. 1). Control path functions may implement sequential functions such as state machines or software running on processors. Control path functions may also exist across multiple stages to coordinate data flow.

In some embodiments, algorithms are partitioned into a hierarchical representation of stages and functions. For example, many PHY implementations include a considerable amount of pipelined processing. A hierarchical representation of a PHY may be produced by breaking down each stage or function until the pipeline is represented by lowest level stages and functions in the hierarchy. The functions that are at the lowest level of the hierarchy are referred to as “leaf” functions. Leaf functions represent atomic functions that are not partitioned further. In some embodiments, leaf functions are represented by a block of code written in a stylized high-level language, a block of code written in a low-level format for a specific PE type, or a library function call.

At 206 in design flow 200, the partitioned code is parsed and optimized. A parser parses the code into tokens, and performs syntactic checking followed by semantic checking. The result is a conversion into an intermediate representation (IR). Any intermediate representation format may be used.

Although optimization is shown concurrently with parsing in design flow 200, there are several points in the design flow where optimization may occur. At this point in the design flow, optimizations such as dead code removal and common expression elimination may be performed. Other PE-independent optimizations may also be performed on the intermediate representation at this point.

At 208 and 210, functions are mapped to PEs. In some embodiments, functions are grouped by selecting various functions that can execute on the same PE type. All functions are assigned to a group, and each group may include any number of functions. Each group may be assigned to a PE, or groups may be combined prior to assigning them to PEs.

In some embodiments, prior to forming groups, all possible PE mappings are enumerated for each function. The hardware topology specification 205 may be utilized to determine the types of resources available in the target reconfigurable circuit. The code in each function may then be analyzed to determine the possible PE types on which the function could successfully map. Some functions may have only one possibility, such as a library function with a single implementation. Library information may be gathered for this purpose from library 260. Other functions may have many possibilities, such as a simple arithmetic function which may be implemented on many different types of PEs. A table may be built that contains all the possibilities of each function, which may be ranked in order of likelihood. This table may be referenced throughout design flow 200.

After the table has been constructed, groups of functions may be formed. Functions that can execute on only one type of PE have limited groups to which they can belong. In some embodiments, user specified constraints 203 may specify a grouping of functions, or may specify a maximum delay or latency that may affect the successful formation of groups. In some embodiments, heuristics may be utilized in determining groupings that are likely to be successful. Information stored in the hierarchical structure created after partitioning may also be utilized.

At 212 in design flow 200, the groups are assigned, or “placed,” to particular PEs in the target configurable circuit. Several factors may guide the placement, including group placement possibilities, user constraints, and the profiler based feedback (described more fully below). Possible placement options are also constrained by information in the hardware topology specification 205. For example, to satisfy tight latency constraints, it may be useful to place two groups on PEs that are next to each other. The placement may also be guided by the directed feedback from the “evaluate and adjust” operation described below.

At 214 in design flow 200, packet routing information is generated to “connect” the various PEs. For example, producer functions are “connected” to appropriate consumer functions for the given mapping and placement. In some embodiments, the connections are performed by specifying the relative address from the PE with a producer function to the appropriate PE with a consumer function. In some cases, the output may be sent to multiple destinations, so a series of relative addresses may be specified.

At 214 of design flow 200, parameters are set. There are a number of parameters that can affect the performance of a mapped and placed protocol. In the constraints file there may be protocol related constraints, such as latency requirements, as well as overall mapping constraints, all of which may affect the setting of parameters. There are several parameters that can be adjusted to meet the specified constraints. Examples include, but are not limited to: input block size for functions, physical output packet size for functions, power supply voltage values for PEs, and PE clock frequency.

The “input block size” of a function may be a variable parameter. Processing elements that include data path functions are generally “data driven,” referring to the manner in which functions operate on blocks of data. In some embodiments, various functions have a parameterizable input block size. These functions collect packets of data until the quantity of received data is equal to or greater than the input block size. The function then operates on the data in the input block. The size of this input block may be parameterizable, and it may also be subject to user constraints. In some embodiments, the input block size is chosen by analyzing such factors as the latency incurred, data throughput required, and the buffering needed in the PE.

A function's physical output packet size may also be a variable parameter. For data path functions, the “output block size” may be related to the function's input block size, as well as other parameters. Regardless of the actual output block size, a PE may send out data in packets that are smaller than the output block size. The size of these smaller packets is referred to as the function's “physical output packet size,” or “physical packet size.” The physical packet size may affect the latency, router bandwidth, data throughput, and buffering by the function's PE. In some embodiments, user-specified constraints may guide the physical output packet size selection either directly or indirectly. For example, physical output packet size may be specified directly in user constraints, or the physical packet size may affected by other user constraints such as latency.

The operating clock frequency of various PEs may also be a variable parameter. Power consumption may be reduced in a configurable circuit by reducing the clock frequency at which one or more PEs operate. In some embodiments, the clock frequency of various PEs is reduced to reduce power consumption, as long as the performance requirements are met. For example, if user constraints specify a maximum latency, the clock frequency of various PEs may be reduced as long as the latency constraint can still be met. In some embodiments, the clock frequency of various PEs may be increased to meet tight latency requirements. In some embodiments, the hardware topology file may show whether clock adjustment is available as a parameter for various PEs.

The power supply voltage of various PEs may also be a variable parameter. Power consumption may be reduced in a configurable circuit by reducing the power supply voltage at which one or more PEs operate. In some embodiments, the power supply voltage of various PEs is reduced to reduce power consumption, as long as the performance requirements are met. For example, if user constraints specify a maximum latency, the power supply voltage of various PEs may be reduced as long as the latency constraint can still be met. In some embodiments, the power supply voltage of various PEs may be increased to meet tight latency requirements. In some embodiments, the hardware topology file may show whether power supply voltage adjustment is available as a parameter for various PEs.

At 216, 218, and 220 of design flow 200, code is generated for various types of PEs. In some embodiments, different code generation tools exist for different types of PEs. For example, a PE that includes programmable logic may have code generated by a translator that translates the intermediate representation of logic equations into tables of information to configure the PE. Also for example, a PE that includes a processor or controller may have code generated by an assembler or compiler. In some embodiments, code is generated for each function, and then the code for a group of functions is generated for a PE. In other embodiments, code for a PE is generated from a group of functions in one operation. Configuration packets are generated to program the various PEs. Configuration packets may include the data to configure a particular PE, and may also include the address of the PE to be configured. In some embodiments, the address of the PE is specified as a relative address from the IO element that is used to communicate with the host.

At 222 of design flow 200, a protocol file is created. The creation of the protocol file may take into account information in the hardware topology file and the generated configuration packets. The quality of the current configuration as specified by the protocol file may be measured by the system profiler 262. In some embodiments, the system profiler 262 allows the gathering of information that may be compared against the user constraints to determine the quality of the current configuration. For example, the system profiler 262 may be utilized to determine whether the user specified latency or throughput requirements can be met given the current protocol layout. The system profiler passes the data regarding latency, throughput, and other performance results to the “evaluate and adjust” block at 226.

System profiler 262 may be a software program that emulates a configurable circuit, or may be a hardware device that accelerates profiling. In some embodiments, system profiler 262 includes a configurable circuit that is the same as the target configurable circuit. In other embodiments, system profiler 262 includes a configurable circuit that is similar to the target configurable circuit. System profiler 262 may accept the configuration packets through any kind of interface, including any type of serial or parallel interface.

At 226 of design flow 200, the current protocol is evaluated and adjusted. Data received from the system profiler may be utilized to determine whether the user specified constraints were met. Evaluation may include evaluating a cost function that takes into account many possible parameters, including the user specified constraints. Parameter adjustments may be made to change the behavior of the protocol, in an attempt to meet the specified constraints. The parameters to be adjusted are then fed back to the various operations (i.e. group, place, set parameters), and the process is repeated until the constraints are met or another stop condition is reached (e.g. maximum numbers of iterations to attempt).

A completed protocol is output from 226 when the constraints are met. In some embodiments, the completed protocol is in the form of a file that specifies the configuration of a configurable circuit such as configurable circuit 100 (FIG. 1). In some embodiments, the completed protocol is in the form of configuration packets to be loaded into a configurable circuit such as configurable circuit 100. The form taken by the completed protocol is not a limitation of the present invention.

The design flow described above with reference to FIG. 2 may be implemented in whole or in part by a computer or other electronic system. For example, in some embodiments, all of design flow 200 may be implemented within a compiler to compile protocols for configurable circuits. In other embodiments, portions of design flow 200 may be implemented in a compiler, and portions of design flow 200 may be performed by a user. For example, in some embodiments, a user may perform partitioning into stages, partitioning into functions, or both. In these embodiments, a compiler that implements the remainder of design flow 200 may receive a design description represented by the outputs of block 202 or 204 as shown in FIG. 2.

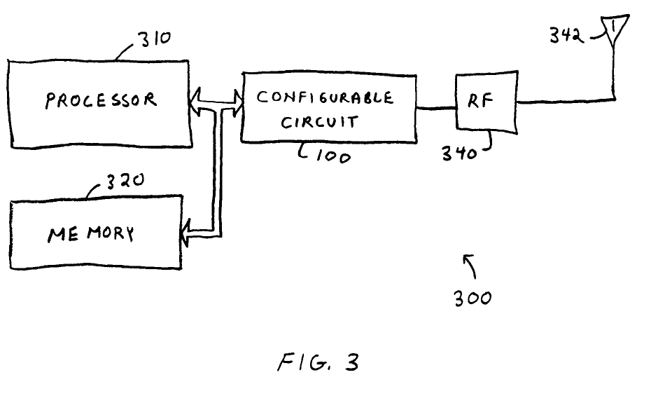

FIG. 3 shows a block diagram of an electronic system. System 300 includes processor 310, memory 320, configurable circuit 100, RF interface 340, and antenna 342. In some embodiments, system 300 may be a computer system to develop protocols for use in configurable circuit 100. For example, system 300 may be a personal computer, a workstation, a dedicated development station, or any other computing device capable of creating a protocol for configurable circuit 100. In other embodiments, system 300 may be an “end-use” system that utilizes configurable circuit 100 after it has been programmed to implement a particular protocol. Further, in some embodiments, system 300 may be a system capable of developing protocols as well as using them.

In some embodiments, processor 310 may be a processor that can perform methods implementing all of design flow 200, or portions of design flow 200. For example, processor 310 may perform function grouping, placement, mapping, profiling, and setting of parameters, or any combination thereof. Processor 310 represents any type of processor, including but not limited to, a microprocessor, a microcontroller, a digital signal processor, a personal computer, a workstation, or the like.

In some embodiments, system 300 may be a communications system, and processor 310 may be a computing device that performs various tasks within the communications system. For example, system 300 may be a system that provides wireless networking capabilities to a computer. In these embodiments, processor 310 may implement all or a portion of a device driver, or may implement a lower level MAC. Also in these embodiments, configurable circuit 100 may implement one or more protocols for wireless network connectivity. In some embodiments, configurable circuit 100 may implement multiple protocols simultaneously, and in other embodiments, processor 310 may change the protocol in use by reconfiguring configurable circuit 100.

Memory 320 represents an article that includes a machine readable medium. For example, memory 320 represents any one or more of the following: a hard disk, a floppy disk, random access memory (RAM), dynamic random access memory (DRAM), static random access memory (SRAM), read only memory (ROM), flash memory, CDROM, or any other type of article that includes a medium readable by a machine such as processor 310. In some embodiments, memory 320 can store instructions for performing the execution of the various method embodiments of the present invention.

In operation of some embodiments, processor 310 reads instructions and data from memory 320 and performs actions in response thereto. For example, various method embodiments of the present invention may be performed by processor 310 while reading instructions from memory 320.

Antenna 342 may be either a directional antenna or an omni-directional antenna. For example, in some embodiments, antenna 342 may be an omni-directional antenna such as a dipole antenna, or a quarter-wave antenna. Also for example, in some embodiments, antenna 342 may be a directional antenna such as a parabolic dish antenna or a Yagi antenna. In some embodiments, antenna 342 is omitted.

In some embodiments, RF signals transmitted or received by antenna 342 may correspond to voice signals, data signals, or any combination thereof. For example, in some embodiments, configurable circuit 100 may implement a protocol for a wireless local area network interface, cellular phone interface, global positioning system (GPS) interface, or the like. In these various embodiments, RF interface 340 may operate at the appropriate frequency for the protocol implemented by configurable circuit 100. In some embodiments, RF interface 340 is omitted.

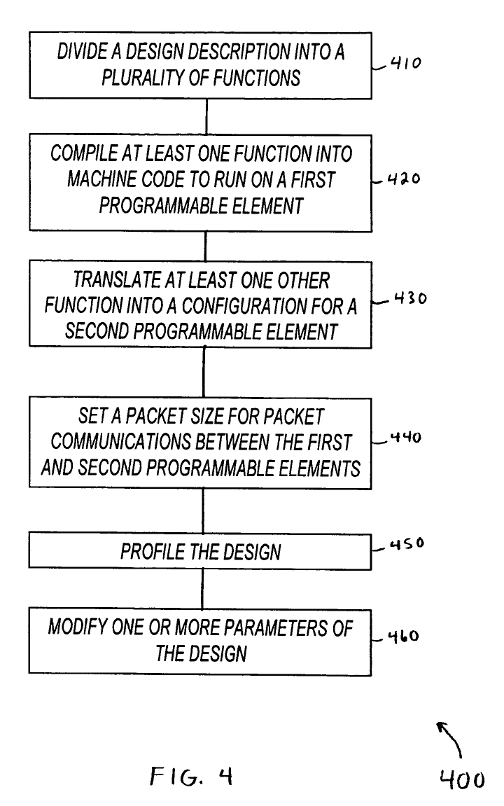

FIG. 4 shows a flowchart in accordance with various embodiments of the present invention. In some embodiments, method 400, or portions thereof, is performed by an electronic system, or an electronic system in conjunction with a person's actions. In other embodiments, all or a portion of method 400 is performed by a control circuit or processor, embodiments of which are shown in the various figures. Method 400 is not limited by the particular type of apparatus, software element, or person performing the method. The various actions in method 400 may be performed in the order presented, or may be performed in a different order. Further, in some embodiments, some actions listed in FIG. 4 are omitted from method 400.

Method 400 is shown beginning with block 410 where a design description is divided into a plurality of functions. In some embodiments, block 410 corresponds to block 204 in design flow 200. The design description may be divided into functions by a person that generates a high-level description, or the design description may be divided into functions by a machine executing all or a portion of method 400. In some embodiments, the design description may also be divided into control and data path portions when the design description is partitioned into stages or functions. For example, when the design description is divided into non-overlapping stages, such as at 202 in design flow 200, one subset of stages may represent control path portions, while another subset of stages may represent data path portions. Also for example, when the design description is divided into functions, such as at 204 in design flow 200, some functions may represent data path portions, while other functions may represent control path portions.

At 420, at least one function is compiled into machine code to run on a first PE. For example, referring now to FIG. 2, one of code generators 216, 218, or 220 may compile statements into machine code to run on a PE. At 430, at least one other function is translated into a configuration for a second PE. The operation represented by 430 includes any kind of translation or configuration other than compiling into machine code. For example, a PE that does not include a processor may be the second PE referred to in 430. In some embodiments, actions in blocks 420 and 430 are repeated for many PEs. For example, the actions of blocks 420 and 430 may be repeated until all functions of a high-level description have been assigned to PEs.

At 440, a packet size is set for packet communications between the first and second PEs. In some embodiments, many different packet sizes are set. For example, different types of packets may be sent between the first and second PEs, where the different types of packets are different sizes. Also for example, more than two PEs may be utilized, and multiple different packet types may be used for communication between the various PEs.

At 450, the design is profiled. The design referred to in 450 includes the configuration information for the various PEs. For example, referring now back to FIG. 2, the protocol file generated at 222 represents the designed to be profiled. Profiling may be accomplished using one or more of many different methods. For example, a system profiler running in software may profile the design. Also for example, the target system including a configurable circuit may be employed to profile the design. The type of hardware or software used to profile the design is not a limitation of the present invention.

At 460, one or more parameters of the design may be modified. For example, in response to profiling, one or more packet size set at 440 may be modified. Also for example, power supply voltage values for various PEs may be modified. Also for example, operating clock frequencies for various PEs may be modified. In some embodiments, parameters are modified in an attempt to satisfy user constraints such as those shown at 203 in FIG. 2. Any type of parameter modifiable in a design flow may be modified without departing from the scope of the present invention.

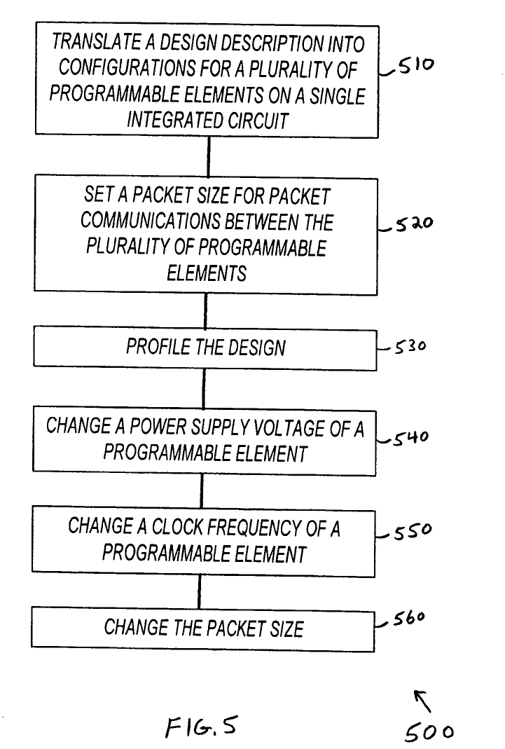

FIG. 5 shows a flowchart in accordance with various embodiments of the present invention. In some embodiments, method 500, or portions thereof, is performed by an electronic system, or an electronic system in conjunction with a person's actions. In other embodiments, all or a portion of method 500 is performed by a control circuit or processor, embodiments of which are shown in the various figures. Method 500 is not limited by the particular type of apparatus, software element, or person performing the method. The various actions in method 500 may be performed in the order presented, or may be performed in a different order. Further, in some embodiments, some actions listed in FIG. 5 are omitted from method 500.

Method 500 is shown beginning with block 510 where a design description is translated into configurations for a plurality of PEs on a single integrated circuit. For example, a design description such as that shown at 201 in FIG. 2 may be translated into configurations for PEs such as those shown in FIG. 1. In some embodiments, translating a design description may include many operations. For example, a design description may be in a high level language, and translating the design description may include partitioning, parsing, grouping, placement, and the like. In other embodiments, translating a design description may include few operations. For example, a design description may be represented using an intermediate representation, and translating the design description may include generating code for the various PEs.

At 520, a packet size is set for packet communications between the plurality of PEs. In some embodiments, many different packet sizes are set. For example, different types of packets may be sent between the plurality of PEs, where the different types of packets are different sizes. Also for example, different configurations may utilize various different PEs, and the different PEs may communicate with each other using different size packets.

At 530, the design is profiled. The design referred to in 530 includes the configuration information for the various PEs. For example, referring now back to FIG. 2, the protocol file generated at 222 represents the designed to be profiled. Profiling may be accomplished using one or more of many different methods. For example, a system profiler running in software may profile the design. Also for example, a target system including a configurable circuit may be employed to profile the design. The type of hardware or software used to profile the design is not a limitation of the present invention.

At 540, a power supply voltage of a PE is changed. This may be performed in response to the profiling at 530. For example, if, after profiling the design, the speed of a particular PE is to be increased, the power supply voltage of the PE may be increased. Also for example, if the speed of the PE is greater than required, the power supply voltage of the PE may be reduced to reduce power consumption.

At 550, a clock frequency of a PE is changed. This may be performed in response to the profiling at 530. For example, if, after profiling the design, the speed of a particular PE is to be increased, the clock frequency of the PE may be increased. Also for example, if the speed of the PE is greater than required, the clock frequency of the PE may be decreased to reduce power consumption.

At 560, a packet size is changed. This may be performed in response to the profiling at 530. For example, packet sizes may be decreased to reduced latency, or may be increased to increased latency. In some embodiments, packet sizes are modified to match block sizes (such as the input block size of a function). In other embodiments, packet sizes are modified such that they are larger or smaller than block sizes.

Blocks 540, 550, and 560 describe a process of changing parameters to modify the behavior of a design. In some embodiments, many parameters relating to the operation of PEs may be changed as part of method 500.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

1. A method comprising:
translating a design description into configurations for a plurality of processing elements on a single integrated circuit; and
setting at least one packet size for packet communications between the plurality of processing elements on the single integrated circuit.

2. The method of claim 1 wherein translating comprises partitioning the design into a plurality of functions.

3. The method of claim 2 wherein translating further comprises compiling the plurality of functions to code to run on at least one of the plurality of processing elements.

4. The method of claim 1 further comprising profiling a design represented by the configurations for the plurality of processing elements.

5. The method of claim 4 further comprising changing a power supply voltage value in response to the profiling.

6. The method of claim 4 further comprising changing a clock frequency in response to the profiling.

7. The method of claim 4 further comprising changing the at least one packet size in response to the profiling.

8. The method of claim 4 wherein profiling produces information describing latency.

9. The method of claim 4 wherein profiling produces information describing throughput.

10. The method of claim 4 further comprising comparing user constraints with output from the profiling.

11. The method of claim 10 wherein the user constraints include latency.

12. The method of claim 10 wherein the user constraints include throughput.

13. The method of claim 4 further comprising modifying parameters of the processing elements in response to the profiling.

14. A method comprising:
dividing a design description into a plurality of functions;
compiling at least one function into machine code to run on a first processing element;
translating at least one other function into a configuration for a second processing element; and
setting a packet size for packet communications between the first and second processing elements.

15. The method of claim 14 further comprising generating configuration packets to configure an integrated circuit that includes the first and second processing elements.

16. The method of claim 15 further comprising configuring the integrated circuit with the configuration packets.

17. The method of claim 14 wherein translating at least one other function comprises translating a plurality of other functions into a configuration for the second processing element.

18. The method of claim 14 further comprising profiling a design with the configuration packets.

19. The method of claim 18 further comprising modifying the packet size in response to the profiling.

20. The method of claim 18 further comprising modifying a power supply voltage of the first processing element in response to the profiling.

21. The method of claim 18 further comprising modifying a power supply voltage of the second processing element in response to the profiling.

22. The method of claim 18 further comprising modifying a clock frequency of the first processing element in response to the profiling.

23. The method of claim 18 further comprising modifying a clock frequency of the second processing element in response to the profiling.

24. An apparatus including a medium to hold machine-accessible instructions that when accessed result in a machine performing:
reading a design description;
compiling the design description to configure a plurality of processing elements; and
determining a packet size for communications between at least two of the plurality of processing elements.

25. The apparatus of claim 24 wherein the machine-accessible instructions when accessed further result in the machine performing:
profiling the design; and
modifying at least one parameter in response to the profiling.

26. The apparatus of claim 25 wherein modifying at least one parameter comprises modifying a clock rate of at least one of the plurality of processing elements.

27. The apparatus of claim 25 wherein modifying at least one parameter comprises modifying the packet size.

28. An electronic system comprising:
a processing element; and
a static random access memory to hold instructions that when accessed result in the processing element performing reading a design description, compiling the design description to configure a plurality of processing elements, and determining a packet size for communications between at least two of the plurality of processing elements.

29. The electronic system of claim 28 wherein the instructions when accessed further result in the processing element performing profiling the design, and modifying at least one parameter in response to the profiling.

30. The electronic system of claim 29 wherein modifying at least one parameter comprises modifying the packet size.
